(19) United States
(12) Patent Application Publication
(10) Pub. No.: US 2026/0208792 A1
(43) Pub. Date: Jul. 23, 2026

(54) CRASH SYSTEM OF A DRIVE ARRANGEMENT OF A MOTOR VEHICLE AND MOTOR VEHICLE

(71) Applicant: AUDI AG, Ingolstadt (DE)

(72) Inventors: Sebastian ALBL, Weinboehla (DE); Thomas HAHN, Böhmfeld (DE); Annegret MALLACH, Thalmässing (DE)

(73) Assignee: AUDI AG, Ingolstadt (DE)

(21) Appl. No.: 19/434,825

(22) Filed: Dec. 29, 2025

(30) Foreign Application Priority Data
Jan. 23, 2025 (DE) 102025102339.5

(51) Int. Cl. B62D 21/11; B60K 1/00; B62D 21/03

(52) U.S. Cl. CPC B62D 21/11; B60K 1/00; B62D 21/03

(57) ABSTRACT

A crash system for a drive arrangement of a motor vehicle, including a drive unit, a bearing unit with a first bearing and two second bearings, a support unit with a cross member and/or a longitudinal member, and a subframe. The drive unit is coupled to the first and second bearings respectively. The first bearing is positioned in front of the second bearings in the longitudinal direction of the vehicle. The second bearings are located on the support unit. The second bearings are arranged in the vehicle vertical direction above the first bearing. When a force is applied to the drive unit from the front in the longitudinal direction of the vehicle, the bearing unit is operatively connected to the support unit so the drive unit is rotated about a pivot point formed along the transverse direction of the vehicle.

### FIELD

The invention relates to a crash system of a drive arrangement of a motor, as well as to a motor vehicle.

### BACKGROUND

In a frontal collision, the kinematics of the powertrain are crucial for energy absorption and the protection of the passenger cell. In this context, the block dimension, which defines the maximum physical extent of the drive unit in the assembled state, plays a central role, as it significantly influences the behavior of the system during the crash. In particular, the block dimension significantly influences the availability and effectiveness of the deformation space in the front of the vehicle, as well as the controlled energy absorption of the vehicle body.

The kinematics of the drive system in the event of a crash are highly dependent on its connection to the vehicle structure. Typical movement patterns comprise axial displacement along the vehicle longitudinal axis, rotational and tilting movements as a result of asymmetric force application, and vertical compression into the deformation zone of the front end. The block dimension significantly influences these movements and has a direct impact on the efficiency of energy absorption and the structural integrity of adjacent vehicle components, especially the battery and the passenger cell.

A smaller block dimension allows for optimized use of the deformation space and promotes orderly deformation of the surrounding structures, thereby increasing the safety of the vehicle occupants. In contrast, a larger block dimension can limit the deformability of the front end and transfer uncontrolled forces to adjacent critical structural elements. To optimize crash kinematics, a compact design of the drive system and its targeted integration into the vehicle structure are therefore crucial. This comprises, among other things, the use of predetermined breaking points and energy absorbers for controlled force application, as well as connection to reinforcing elements such as crossbeams to ensure even load distribution.

It is already known to provide an arrangement to protect the passenger compartment and vehicle occupants in a frontal crash, which guides or limits the movement of the drive unit in the longitudinal direction of the vehicle in a frontal crash.

In DE 10 2009 055 719 A1, the movement of the drive unit is limited by coupling the drive unit with a push rod. The push rod is designed to be rotatable on the one hand and movable in the longitudinal direction of the vehicle on the other. This causes the drive unit to be displaced both backwards in the vehicle longitudinal direction and downwards in the vehicle vertical direction in a frontal crash.

DE 10 2019 207 584 A1 discloses that the drive unit is mounted in a guide track which, in the event of an accident-related force impact from a frontal crash, enables a defined relative displacement of the drive unit along the guide track. This movement occurs in the longitudinal and vertical directions of the vehicle and results in the drive unit being moved in a controlled manner towards a holding element.

However, these known measures to protect the passenger compartment and vehicle occupants in a frontal crash have the disadvantage that the axial displacement of the drive unit in the vehicle longitudinal direction results in a high mechanical impulse on the passenger cell. A short front end or region of the vehicle in front of the drive unit in relation to the vehicle longitudinal direction is not feasible with a high installation space density.

### SUMMARY

The object of the invention is therefore to ensure a lower mechanical impulse on the passenger compartment and for the vehicle occupants in a frontal crash, while simultaneously minimizing the intrusion of the drive system into the passenger compartment.

The present invention enables a safe and efficient integration of a drive unit in the front of a vehicle, which maximizes energy absorption in a frontal impact and ensures the structural integrity of the vehicle, in particular the passenger cell.

In a known manner, a crash system of a drive arrangement of a motor vehicle comprises a drive unit, a bearing unit with a first bearing and two second bearings, a support unit having a cross member and/or longitudinal member, and a subframe. The drive unit is designed in particular as an electric motor. The drive unit is coupled to the first bearing and the second bearings respectively. The first bearing is positioned in front of the second bearings in the longitudinal direction of the vehicle. The second bearings are located on the support unit.

According to the invention, the second bearings are arranged above the first bearing in the vehicle vertical direction. When a force is applied to the drive unit from the front in the longitudinal direction of the vehicle, the bearing unit is operatively connected to the support unit in such a way that the drive unit can be rotated about a pivot point formed along the transverse direction of the vehicle. The pivot points of the second bearings can be formed together or offset from each other. Since the pivot point of the drive unit is located in the region of the second bearing and, in the event of a frontal crash, the energy is directed to the drive unit through a barrier in the region of the first bearing, simple and reliable pivoting of the drive unit is ensured. This results in a short block dimension of the drive unit after a frontal crash. The deflection path or displacement path of the drive unit corresponds to a circular path that refers to the pivot point of the drive unit.

According to a further advantageous embodiment of the invention, the second bearings are designed as aggregate bearings. The aggregate bearings are aligned in the transverse direction of the vehicle. The aggregate bearing each comprises a support spring, in particular a rubber element, an outer ring and a bearing core. The bearing core is arranged radially inside the outer ring. The support spring acts in a radial direction between the bearing core and the outer ring. The outer ring is firmly connected to the drive unit. The bearing core is firmly connected to the footwell cross member and/or longitudinal member. This can cause the support spring to give way in a crash or break under higher loads. The drive unit remains limited in the radial direction by the interaction of the outer ring with the bearing core, such that the force applied due to the frontal crash results in a rotational moment with the pivot point at the rear bearing points, thereby reducing the block dimension of the drive during the crash. This allows the body structure to deform better and absorb energy.

Preferably, the bearing core is connected to the support unit via a double-shear screw connection. This distributes the load acting on the bearing core across two interfaces, allowing the bolted connection to withstand higher forces. Furthermore, the double shear surface reduces the stress on the screw compared to single-shear connections.

Preferably, the second bearings are attached to the footwell cross member and the longitudinal member. By connecting the second bearings to both the footwell cross member and the longitudinal member, a high counterforce of the second bearing is formed with respect to a force resulting from the frontal crash in the longitudinal direction of the vehicle, so that the drive unit is fixed in the longitudinal direction of the vehicle via the second bearings.

According to a further preferred embodiment of the invention, the first bearing has a distance of greater than or equal to 150 mm and less than or equal to 350 mm to the second bearings with respect to the vehicle vertical direction.

Preferably, the drive unit is connected to the subframe or auxiliary frame of the motor vehicle via the first bearing.

According to a further advantageous embodiment of the invention, all bearings are designed as rubber-metal bearings. The elastic bearing allows vibrations and shocks to be absorbed, thereby increasing the driving comfort for the vehicle occupants.

Preferably, the second bearings have a common pivot point, which is designed as an axis of rotation. In the event of a frontal crash, the resulting energy is transferred to the drive unit perpendicular to the axis of rotation, so that the rotation of the drive unit firstly extends the time period of force build-up due to the frontal crash, which reduces the peak load on the overall system, and secondly, the axial force component in the longitudinal direction of the vehicle is dissipated via the support of the second bearings on longitudinal and footwell cross members.

A further aspect of the invention relates to motor vehicles, having at least one crash system of a drive arrangement of a motor vehicle comprising a drive unit, a bearing unit with a first bearing and two second bearings, a support unit having a cross member and/or longitudinal member, and a subframe. The drive unit is designed in particular as an electric motor. The drive unit is coupled to the first bearing and the two second bearings respectively. The first bearing is positioned in front of the second bearings in the longitudinal direction of the vehicle. The second bearings are located on the support unit.

According to the invention, the crash system is designed as described.

### BRIEF DESCRIPTION OF THE FIGURES

Further advantages and possible uses of the invention will be apparent from the following description in conjunction with embodiments shown in the drawings.

FIG. 1 shows a schematic side view of the drive arrangement of a motor vehicle before a frontal crash;

FIG. 2 shows a schematic side view of the drive arrangement of a motor vehicle after a frontal crash; and

FIG. 3 shows a schematic plan view of the second bearings of the drive arrangement.

### DETAILED DESCRIPTION

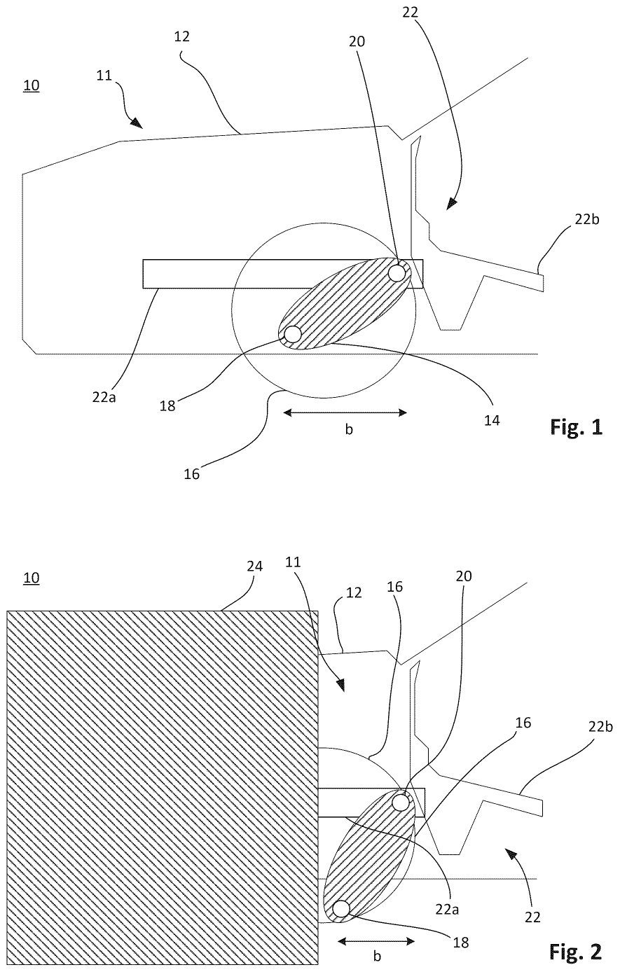

FIGS. 1 and 2 each show a crash system 10 of a drive arrangement 11 of a motor vehicle. The drive arrangement 11 is located in the front section 12 of the motor vehicle and includes a drive unit 14. A support unit 22 is arranged in the longitudinal direction of the vehicle behind the wheel 16. The support unit 22 comprises the longitudinal member 22a and the footwell cross member 22b of the motor vehicle. Longitudinal member 22a and footwell cross member 22b are firmly connected to each other, in particular via a welded connection. The support unit 22 is designed to protect the vehicle interior and the vehicle occupants inside in the event of a crash.

The drive unit 14 is connected to the motor vehicle via two different bearings 18, 20. One first bearing 18 and two second bearings 20 are formed. The first bearing 18 is located between the drive unit 14 and the chassis of the motor vehicle. The first bearing 18 is part of the subframe or the auxiliary frame of the motor vehicle. The second bearings 20 are formed between the drive unit 14 and the support unit 22 and are part of the support unit 22.

The first bearing 18 is designed in such a way that the end of the drive unit 14 associated with the subframe can be displaced in the longitudinal direction of the vehicle and in the vertical direction of the vehicle. Bearings 18,20 are designed as rubber-metal bearings.

The second bearings 20 are each designed as aggregate bearings. The second bearings 20 are aligned in the transverse direction of the vehicle. The second bearings 20 each have a bearing core, a support spring and an outer ring. The support spring acts in a radial direction between the bearing core and the outer ring. The support spring is designed as a rubber element. Preferably, the bearing core is firmly connected to the support unit 22 via a double-shear screw connection. The outer ring is firmly connected to the drive unit 14. The support unit 22 counteracts an axial movement of the end of the drive unit 14 associated with the support unit 22 in the longitudinal direction of the vehicle by means of support on the support unit 22, while a rotation of the drive unit 14 about a pivot point 26a, 26b is permitted.

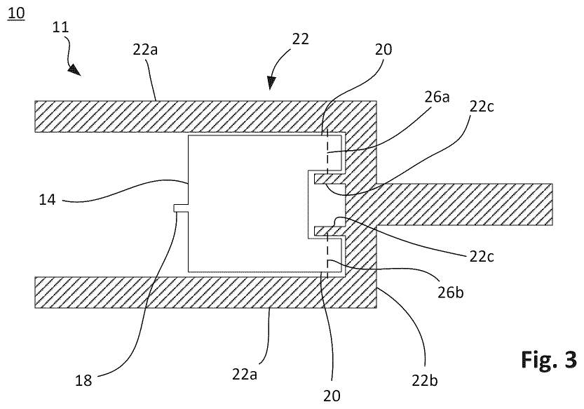

The axial movement of the drive unit 14 in the longitudinal direction of the vehicle is limited to the spring travel of the support spring. Under heavier stresses, the support spring can also be destroyed, so that the axial movement in the longitudinal direction of the vehicle of the drive unit is limited by the radial distance of the bearing core to the outer ring. With optimal rotation around the vehicle transverse axis, the pivot point is designed as rotation axis 26a, 26b. FIG. 3 shows that the axes of rotation 26a, 26b of the second bearings 20 are each perpendicular to the longitudinal direction of the vehicle or in the transverse direction of the vehicle and coaxial.

FIG. 1 shows the crash system 10 of the drive arrangement 11 before a frontal crash, i.e. in the regular driving operation of the motor vehicle. The first bearing 18 is positioned in front of the second bearings 20 in the longitudinal direction of the vehicle. With respect to the vehicle vertical direction, the first bearing 18 is located below the second bearing 20. The distance between the front and rear ends of the drive unit 14 in the longitudinal direction of the vehicle is designed as a block dimension b.

FIG. 2 shows the crash system 10 of the drive arrangement 11 after a frontal crash with a barrier 24. Due to the impact of the motor vehicle on the barrier 24, the drive unit 14 is pivoted about the common pivot point formed in the area of the second bearings 20, so that the end of the drive unit 14 associated with the subframe is pivoted downwards in the vertical direction of the vehicle and backwards in the longitudinal direction of the vehicle compared to the regular driving operation according to FIG. 1. The position of the end of the drive unit 14 assigned to the second bearings 20 is limited to the distance from the bearing core to the outer ring of the second bearings 20 in comparison to regular driving operation according to FIG. 1.

The block dimension b before the frontal crash according to FIG. 1 is larger than the block dimension b after the frontal crash according to FIG. 2.

Due to the reduced block dimension b of the drive arrangement 11, the longitudinal member 22a can deform for a longer period and thus absorb more energy.

FIG. 3 shows the connection of the drive unit 14 via the second bearings 20.

The bearing cores of the second bearings 20 are each connected to the support unit 22 by two shear connections. The support unit 22 has two legs 22a running parallel in the longitudinal direction of the vehicle. The legs 22a are each connected to one another at one end by an end piece 22b that runs perpendicular to the legs 22a. Between the legs 22a, the end piece 22b has two spaced-apart projections 22c.

The drive unit 14 is arranged between the legs 22a. The drive unit 14 is respectively arranged with the second bearing 20 between one of the projections 22c and one of the legs 22a. A screw connects the bearing core of the second bearing 20 to the support element 22, the screw being screwed to a projection 20c and a leg 20a, as well as to the bearing core. The interfaces of the double-shear connection are formed between the bearing core and projection 20c, as well as between the bearing core and leg 20a.

The design of the crash system of the drive arrangement 11 according to the invention ensures that the force acting in a frontal crash can be reduced in the axial direction via the support unit 22 and at the same time a small block dimension of the drive unit 14 is ensured by a rotation of the drive unit 14 about a pivot point or an axis of rotation, which makes it possible to realize a short front end 12. Furthermore, due to the extension of the deflection path or displacement path caused by the rotation of the drive unit 14, a smaller impulse acts on the passenger compartment and accordingly on the vehicle occupants.

1. A crash system for a drive arrangement of a motor vehicle, comprising: a drive unit, a bearing unit with a first bearing and two second bearings, a support unit having a cross member and/or longitudinal member, and a subframe, wherein the drive unit is coupled to the first bearing and the second bearings respectively, wherein the first bearing is arranged in the longitudinal direction of the vehicle in front of the second bearings, and wherein the second bearings are arranged on the support unit,
wherein the second bearings are arranged in the vertical direction of the vehicle above the first bearing, wherein, in the event of a force acting on the drive unit from the front in the longitudinal direction of the vehicle, the bearing unit is operatively connected to the support unit such that the drive unit can be rotated about a pivot point formed along the vehicle transverse direction.

2. The crash system according to claim 1, wherein the second bearings are designed as aggregate bearings and are formed in the transverse direction of the vehicle, comprising an outer ring, a support spring, in particular a rubber element, and a bearing core, wherein the support spring acts in a radial direction between the bearing core and the outer ring, wherein the outer ring is rigidly connected to the drive unit, and wherein the bearing core is rigidly connected to the cross member and/or longitudinal member.

3. The crash system according to claim 2, wherein the bearing core is connected to the support unit via a screw connection with two shear sections.

4. The crash system according to claim 1, wherein the second bearings are connected to the footwell cross member and to the longitudinal member.

5. The crash system according to claim 1, wherein the first bearing has a distance of greater than or equal to 150 mm and less than or equal to 350 mm to the second bearings with respect to the vehicle vertical direction of the motor vehicle.

6. The crash system according to claim 1, wherein the drive unit is connected to the subframe via the first bearing.

7. The crash system according to claim 1, wherein the bearings are designed as rubber-metal bearings.

8. A motor vehicle, having at least one crash system for a drive arrangement of a motor vehicle, comprising a drive unit, a bearing unit with a first bearing and two second bearings, a support unit having a cross member and/or longitudinal member, and a subframe, wherein the drive unit is coupled to the first bearing and the second bearings respectively, wherein the first bearing is arranged in the longitudinal direction of the vehicle in front of the second bearings, and wherein the second bearings are arranged on the support unit, wherein the crash system is formed according to claim 1.

9. The crash system according to claim 2, wherein the second bearings are connected to the footwell cross member and to the longitudinal member.

10. The crash system according to claim 3, wherein the second bearings are connected to the footwell cross member and to the longitudinal member.

11. The crash system according to claim 2, wherein the first bearing has a distance of greater than or equal to 150 mm and less than or equal to 350 mm to the second bearings with respect to the vehicle vertical direction of the motor vehicle.

12. The crash system according to claim 3, wherein the first bearing has a distance of greater than or equal to 150 mm and less than or equal to 350 mm to the second bearings with respect to the vehicle vertical direction of the motor vehicle.

13. The crash system according to claim 4, wherein the first bearing has a distance of greater than or equal to 150 mm and less than or equal to 350 mm to the second bearings with respect to the vehicle vertical direction of the motor vehicle.

14. The crash system according to claim 2, wherein the drive unit is connected to the subframe via the first bearing.

15. The crash system according to claim 3, wherein the drive unit is connected to the subframe via the first bearing.

16. The crash system according to claim 4, wherein the drive unit is connected to the subframe via the first bearing.

17. The crash system according to claim 5, wherein the drive unit is connected to the subframe via the first bearing.

18. The crash system according to claim 2, wherein the bearings are designed as rubber-metal bearings.

19. The crash system according to claim 3, wherein the bearings are designed as rubber-metal bearings.

20. The crash system according to claim 4, wherein the bearings are designed as rubber-metal bearings.
